(19) United States
(12) Patent Application Publication
(10) Pub. No.: US 2004/0223639 A1
(43) Pub. Date: Nov. 11, 2004

(54) System for creating an inspection recipe, system for reviewing defects, method for creating an inspection recipe and method for reviewing defects

(76) Inventor: Yoshiyuki Sato, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/770,408

(22) Filed: Feb. 4, 2004

(30) Foreign Application Priority Data
Mar. 14, 2003 (JP) P2003-070447

(51) Int. Cl. G06K 9/00

(52) U.S. Cl. 382/145; 382/168

(57) ABSTRACT

A system for creating an inspection recipe, includes an inspection target selection module selecting an inspection target; a critical area extraction module extracting corresponding critical areas for defect sizes in the inspection target; a defect density prediction module extracting corresponding defect densities predicted by defects to be detected in the inspection target for the defect sizes; a killer defect calculation module calculating corresponding numbers of killer defects in the defect sizes based on the critical areas and the defect densities; and a detection expectation calculation module calculating another numbers of the killer defects expected to be detected for prospective inspection recipes determining rates of defect detection for the defect sizes, based on the numbers of the killer defects and the rates of defect detection prescribed in the prospective inspection recipes.

### CROSS REFERENCE TO RELATED APPLICATIONS

This application is based upon and claims the benefit of priority from prior Japanese Patent Application P2003-070447 filed on Mar. 14, 2003; the entire contents of which are incorporated by reference herein.

### BACKGROUND OF THE INVENTION

1. Field of the Invention

The present invention relates to a system for creating an inspection recipe, a system for reviewing defects, a method for creating the inspection recipe, and a method for reviewing the defects. Particularly, the present invention relates to a system and a method for creating an inspection recipe of a defect inspection apparatus used in a manufacturing process of an electronic device, and the like, and relates to a system and a method for identifying a defect to be reviewed from among a large number of defects detected in an inspection target.

2. Description of the Related Art

In a manufacturing technology for an electronic device, for maintaining and improving a yield rate thereof, it is essential to ascertain a cause of a failure of the electronic device at an early stage and to feed back the cause of the failure to a manufacturing process and a manufacturing apparatus. In order to ascertain the cause of the failure at the early stage, it is required to detect as many defects as possible occurring on the electronic device. For this purpose, it is necessary to set a large number of sensitivity parameters (hereinafter, referred to as an inspection recipe) of a defect inspection apparatus at optimum values in response to an inspection target. Heretofore, the inspection recipe for the defect inspection apparatus has been set by a subjective judgment of an engineer, which is based on the knowledge and experience of the engineer.

Moreover, in order to identify a manufacturing process and a manufacturing apparatus, which may cause the failure, it is necessary to implement a defect review. The defect review is an operation for classifying the defects detected by the defect inspection apparatus for each failure factor by observing the detected defects by use of an optical microscope, a scanning electron microscope (SEM) and the like. A result of the defect review can serve as a very important information source for identifying the failure cause.

With regard to the defect review, a method is known, in which by comparing sizes of the defects with data for determining a possibility (fatality) to be the failure cause in order to calculate the fatality of the defects, the defects are reviewed in descending order of the fatality, for the purpose of performing the defect review efficiently (refer to Japanese Patent Laid-Open No. H11-214462 (published in 1999)). Moreover, an inspection system is known, in which by calculating a rate of failure occurrence for each defect based on data of the rates of failure occurrence in accordance with positions of the defects in a chip, regions of the defects in the chip and the sizes of the defects, the defects in which the rates of failure occurrence are equal to or higher than a reference value are selected, for the purpose of preferentially analyzing defects which are high in fatality (refer to Japanese Patent Laid-Open No. 2002-141384).

In recent years, the number of detected defects has been sharply increased by performance improvement of the defect inspection apparatus and size enlargement of a wafer. Hence, in order to ascertain the failure cause at an early stage, it is necessary to efficiently detect only the defects which have a high fatality from among the defects occurring on the electronic device and to review the detected defects.

However, in the current method for creating an inspection recipe, since the fatality of the defects is not taken into consideration, the inspection recipe by which a large number of microdefects that do not affect an operation of the electronic device are detected, may be undesirably set. Accordingly, it makes it impossible to detect killer defects efficiently. Thus, oversight of serious defects required to be detected may occur, and the oversight of the defects, against which measures should be taken, may cause a delay in the improvement of the yield rate, leading to generation of enormous loss. Moreover, because an engineer creates the inspection recipe by trial and error, it takes an extremely long time to find the optimum inspection recipe. Furthermore, a difference arises in quality of the inspection recipe depending on the degree of skill of the engineer.

In addition, a load on the defect review has been increased because of the sharp increase in the number of detected defects. Even if the review after sampling of killer defects from a large number of detected defects is desired, there has not been a method for efficiently sampling the killer defects under the current situation. From this point of view, a method is required, which is capable for efficiently reviewing the killer defects from among the enormous number of detected defects and identifying a manufacturing process and a manufacturing apparatus having problems at an early stage.

### SUMMARY OF THE INVENTION

A first aspect of the present invention inheres in a system for creating an inspection recipe including an inspection target selection module configured to select an inspection target; a critical area extraction module configured to extract corresponding critical areas for a plurality of defect sizes in the inspection target, respectively; a defect density prediction module configured to extract corresponding defect densities for the defect sizes, the defect densities being predicted by defects to be detected in the inspection target, respectively; a killer defect calculation module configured to calculate corresponding numbers of killer defects in the defect sizes, based on the critical areas and the defect densities; and a detection expectation calculation module configured to calculate respectively another numbers of the killer defects expected to be detected for a plurality of prospective inspection recipes which determine rates of defect detection for the defect sizes, based on the numbers of the killer defects and the rates of defect detection prescribed in the prospective inspection recipes.

A second aspect of the present invention inheres in a system for reviewing a defect including an inspection target selection module configured to select an inspection target; a critical area extraction module configured to extract corresponding critical areas for a plurality of defect sizes in the inspection target, respectively; a detected defect density extraction module configured to extract corresponding defect densities for the defect sizes, respectively, the defect densities being detected in the inspection target; a killer defect calculation module configured to calculate corresponding numbers of killer defects in the defect sizes, respectively, based on the critical areas and the defect densities; and a review number determination module configured to obtain corresponding numbers of defects to be reviewed for the defect sizes based on the numbers of the killer defects, respectively.

A third aspect of the present invention inheres in a computer implemented method for creating an inspection recipe including selecting an inspection target; obtaining corresponding critical areas for a plurality of defect sizes in the inspection target, respectively; obtaining corresponding defect densities for the defect sizes, the defect densities being predicted by defects to be detected in the inspection target, respectively; calculating corresponding numbers of killer defects in the defect sizes, respectively, based on the critical areas and the defect densities; and calculating respectively another numbers of the killer defects expected to be detected for a plurality of prospective inspection recipes which determine rates of defect detection for the defect sizes, based on the numbers of killer defects and the rates of defect detection prescribed in the prospective inspection recipes.

A fourth aspect of the present invention inheres in a computer implemented method for reviewing a defect including selecting an inspection target; obtaining corresponding critical areas for a plurality of defect sizes in the inspection target, respectively; obtaining corresponding defect densities for the defect sizes, respectively, the defect densities being detected in the inspection target; calculating corresponding numbers of killer defects in the defect sizes, respectively, based on the critical areas and the defect densities; and obtaining corresponding numbers of the defects to be reviewed for the defect sizes based on the numbers of the killer defects, respectively.

### BRIEF DESCRIPTION OF DRAWINGS

FIG. 1 is a block diagram illustrating a system for creating an inspection recipe according to a first embodiment of the present invention;

FIG. 2 is a plan view showing defects and a critical area on a line pattern;

FIG. 3 is a graph showing a distribution of a critical area for each defect size;

FIG. 4 is a graph showing distributions of the critical area and an estimated defect density for each defect size.

FIG. 5 is a graph showing the calculated number of killer defects for each defect size;

FIG. 6 is a set of graphs showing the number of killer defects for each defect size, first to third prospective inspection recipes stored in a prospective inspection recipe storage unit of FIG. 1, and the numbers of killer defects expected to be detected by the first to third prospective inspection recipes;

FIG. 7 is a flowchart showing a method for creating the inspection recipe using the system for creating the inspection receipt shown in FIG. 1;

FIG. 8 is a flowchart showing a part of a common manufacturing process of a semiconductor device;

FIG. 9 is a block diagram illustrating a defect review system according to a second embodiment of the present invention;

FIG. 10 is a view showing an example of detected defect information for each wafer, which is stored in a detected defect density storage unit of FIG. 9;

FIG. 11 is a graph showing a detected defect density distribution for each defect size, which is stored in the detected defect density storage unit of FIG. 9;

FIG. 12 is a graph showing the number of killer defects for each defect size, which has been calculated by a killer defect calculation module of FIG. 9;

FIG. 13 is a graph showing a distribution of the number of defects to be reviewed, which has been calculated by a review number determination module of FIG. 9;

FIG. 14 is a table showing for each defect size, data of a detected defect density distribution DD′(R) and a critical area Ac(R) corresponding to those of FIG. 12, a rate of the number of killer defects λ′(R), and the number of defects to be reviewed;

FIG. 15 is a table showing the number of defects classified for each defect mode by a review execution system;

FIG. 16 is a graph showing distributions of the number of defects detected in a current defect review system and the number of defects to be reviewed;

FIG. 17 is a graph created by further adding the number of killer defects λ′(R) shown in FIG. 13 to the graph of FIG. 16; and

FIG. 18 is a flowchart showing a defect review method using the defect review system shown in FIG. 9.

### DETAILED DESCRIPTION OF EMBODIMENTS

An embodiment of the present invention will be described with reference to the accompanying drawings. It is to be noted that the same or similar reference numerals are applied to the same or similar parts and elements throughout the drawings, and the description of the same or similar parts and elements will be omitted or simplified.

(First Embodiment)

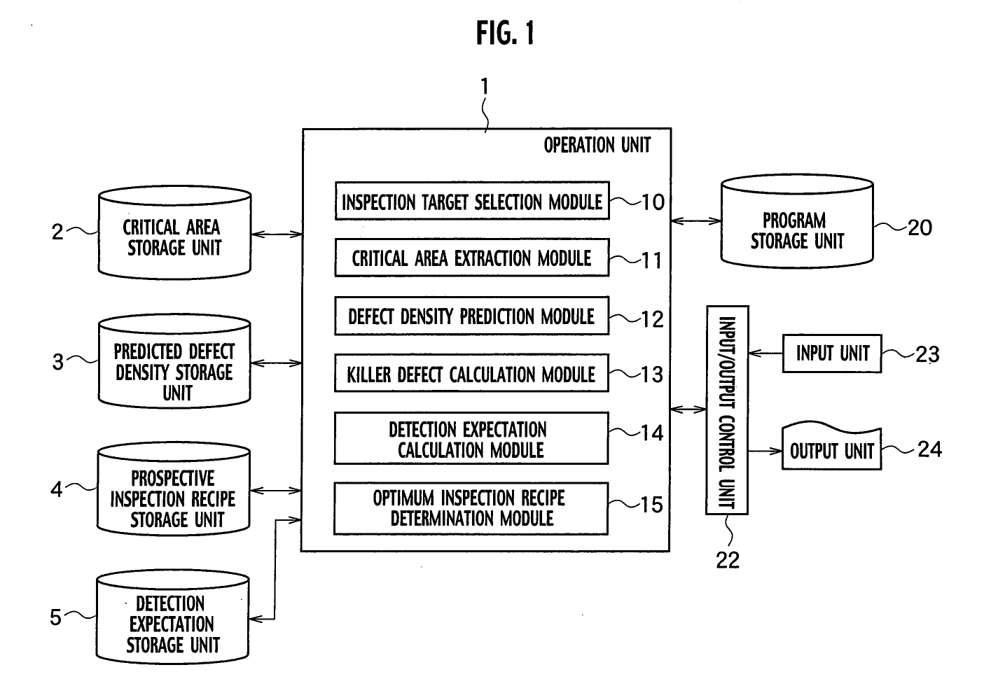

As shown in FIG. 1, a system for creating an inspection recipe according to a first embodiment of the present invention includes an operation unit 1 having a function to create the inspection recipe for a defect inspection apparatus. Additionally, the system for creating the inspection recipe includes a critical area storage unit 2, a predicted defect density storage unit 3, a prospective inspection recipe storage unit 4, a detection expectation storage unit 5, and a program storage unit 20, which are connected to the operation unit 1.

The operation unit 1 includes a inspection target selection module 10 configured to select an inspection target, a critical area extraction module 11 configured to extract critical areas for each of a plurality of defect sizes in the inspection target, a defect density prediction module 12 configured to extract defect densities for each defect size, which are predicted by defects detected in the inspection target, a killer defect calculation module 13 configured to calculate the numbers of killer defects for each defect size based on the critical areas for each defect size and the defect densities for each defect size, a detection expectation calculation module 14 configured to calculate the numbers of killer defects expected to be detected for each of a plurality of prospective inspection recipes which determine rates of defect detection for each defect size, based on the numbers of killer defects and the rates of defect detection prescribed in the prospective inspection recipes, and an optimum inspection recipe determination module 15 configured to obtain a prospective inspection recipe in which the number of killer defects expected to be detected is the largest.

The operation unit 1 may be configured as a part of a central processing unit (CPU) of a common computer system. Each of the inspection target selection module 10, the critical area extraction module 11, the defect density prediction module 12, the killer defect calculation module 13, the detection expectation calculation module 14 and the optimum inspection recipe determination module 15 may be provided by dedicated hardware, respectively, or by software having a substantially equivalent function using a CPU of a common computer system.

Each of the critical area storage unit 2, the predicted defect density storage unit 3, the prospective inspection recipe storage unit 4, the detection expectation storage unit 5 and the program storage unit 20 may be provided by an auxiliary storage unit including a semiconductor memory such as a semiconductor ROM, a semiconductor RAM and the like, a magnetic disk unit, a magnetic drum storage unit and a magnetic tape unit, or by a main memory unit in the CPU.

An input unit 23 for receiving an input such as data and a command from an operator, and an output unit 24 for providing data of a created inspection recipe are connected to the operation unit 1 through an input/output control unit 22. The input unit 23 includes a keyboard, a mouse, a light pen, a flexible disk unit and the like. The output unit 24 includes a printer, a display unit and the like. The display unit includes a CRT, a liquid crystal display and the like.

A program command for each process executed in the operation unit 1 is stored in the program storage unit 20. The program command is read into the CPU as required, and operation processing is executed by the operation unit 1 in the CPU. Simultaneously, data such as numerical information generated at respective stages in the series of operation processing is temporarily stored in the main memory unit in the CPU.

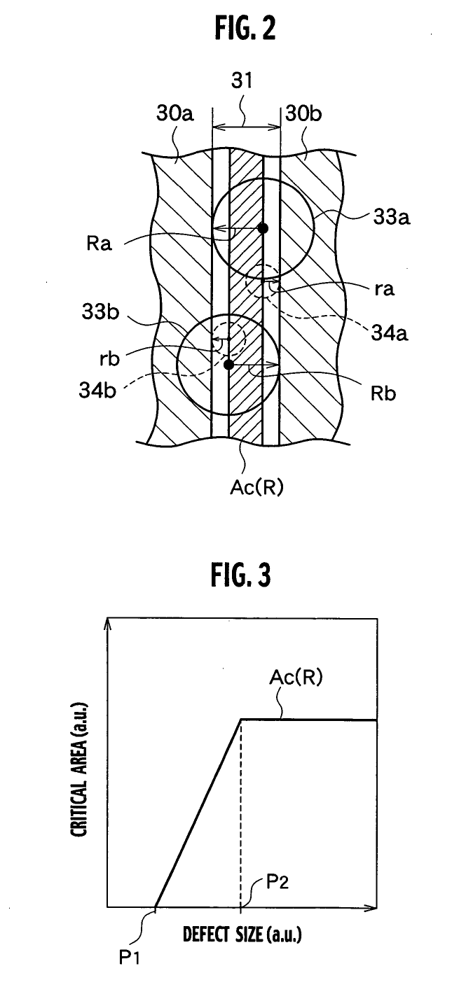

For example, the inspection target selection module 10 designates a type of a product, a manufacturing process of the product and a region in the product as the inspection target. The critical area extraction module 11 extracts the critical area of each defect size in the inspection target selected by the inspection target selection module 10 from the critical area storage unit 2. The “critical area” is a concept indicating a range (probability) where a failure may occur due to the presence of a defect. Details of the critical area will be described later with reference to FIGS. 2 and 3. The defect density prediction module 12 extracts the defect density of each defect size, which is predicted by the defects detected in the inspection target, from the predicted defect density storage unit 3. The killer defect calculation module 13 calculates the number of killer defects of each defect size based on the extracted critical area of each defect size and the defect density of each defect size in the inspection target. The detection expectation calculation module 14 calculates the number of killer defects expected to be detected in the inspection target based on the number of killer defects of each defect size and a rate of defect detection defined in each prospective inspection recipe. As used herein, the term “prospective inspection recipe” refers to a possible inspection recipe that may be used for the inspection process. The optimum inspection recipe determination module 15 obtains an optimum prospective inspection recipe based on the number of killer defects expected to be detected. The optimum prospective inspection recipe is a prospective inspection recipe in which the number of killer defects expected to be detected is the largest.

The critical area storage unit 2 stores information of the critical areas corresponding to each inspection target of the type of the product, the manufacturing process of the product and the region in the product. The information of the critical areas includes the critical area of each defect size.

The predicted defect density storage unit 3 stores information of the defect density that has already been inspected in the past, regarding other products in common with the inspection target product in any one of a manufacturing line, the manufacturing process and a manufacturing apparatus. The prospective inspection recipe storage unit 4 stores information of a plurality of prospective inspection recipes in accordance with the kind of the product, the manufacturing process of the product and the region in the product. The prospective inspection recipes determine a rate of defect detection of each defect size. The rate of defect detection of each defect size is determined by a sensitivity parameter of the defect inspection apparatus. The detection expectation storage unit 5 stores a calculation result of the detection expectation calculation module 14. Specifically, the detection expectation storage unit 5 stores the number of killer defects expected to be detected in the inspection target, which is calculated for each prospective inspection recipe.

The information of the defect density stored by the predicted defect density storage unit 3 is obtained by, for example, evaluating electric characteristics of a test element group (TEG). The information of the defect density may be first information provided by summarizing the numbers of defects and the defect sizes for each wafer or second information provided by converting the first information into the defect density for each defect size. Hence, when the information of the defect density is the second information, the defect density prediction module 12 directly extracts the defect density of each defect size, which is predicted to be detected in the inspection target, from the predicted defect density storage unit 3. When the information of the defect density is the first information, the defect density prediction module 12 reads out the first information from the predicted defect density storage unit 3, and converts the first information to extract the second information.

As shown in FIG. 2, a first wiring 30a and a second wiring 30b are located in parallel with a space 31 interposed therebetween. A first large defect 33a has a circular shape of a radius Ra, abuts the first wiring 30a, and is partially overlapped with the second wiring 30b. A second large defect 33b has a circular shape of a radius Rb equal to the radius Ra, abuts the second wiring 30b, and is partially overlapped with the first wiring 30a. Hence, there is a possibility that the first and second large defects 33a and 33b may provide conduction between the first and second large wirings 30a and 30b to cause a short circuit failure. Specifically, the first and second large defects 33a and 33b can be killer defects interfering with a normal operation of the product to cause an operation failure thereof. Only when centers of the first and second large defects 33a and 33b are located in the critical area Ac(R) in the space 31, the first and second large defects 33a and 33b may be laid across the first and second wirings 30a and 30b so as to be the killer defects. In other words, the critical area Ac(R) indicates a range where failure occurs due to the presence of the first and second large defects 33a and 33b, and an extent of the critical area Ac(R) depends on a layout pattern and the defect size. In the case of assuming a circular defect having a radius R, the extent of the critical area Ac (R) depends on the radius R of the defect. Hereinafter, description will continue concerning the circular defect having the radius R by taking the radius R of the defect as the defect size.

A first small defect 34a has a circular shape of a radius ra, is spaced from the first wiring 30a, and abuts the second wiring 30b. A second small defect 34b has a circular shape of a radius rb equal to the radius ra, is spaced from the second wiring 30b, and abuts the first wiring 30a. The radii ra and rb of the first and second small defects 34a and 34b are smaller than a half the width of the space 31. Therefore, the first and second small defects 34a and 34b can not be laid across the first and second wirings 30a and 30b, and do not provide conduction between the first and second wirings 30a and 30b. Hence, in the first and second small defects 34a and 34b, the critical area Ac(R) does not exist.

As described above, a threshold value determined by the layout pattern exists in the critical area Ac (R). In the line pattern shown in FIG. 2, the critical area Ac(R) arises from a value P1 that is a half of the width of the space 31. As shown in FIG. 3, the critical area Ac(R) increases as the defect size R increases over the value P1. In addition, when the defect size R exceeds a fixed value P2, the critical area Ac(R) reaches a fixed value without increasing. For example, when the value P2 for the defect size R exceeds a sum of the space width and a half of the line width in the case where the line pattern shown in FIG. 2 is repeated, the critical area Ac(R) is constant.

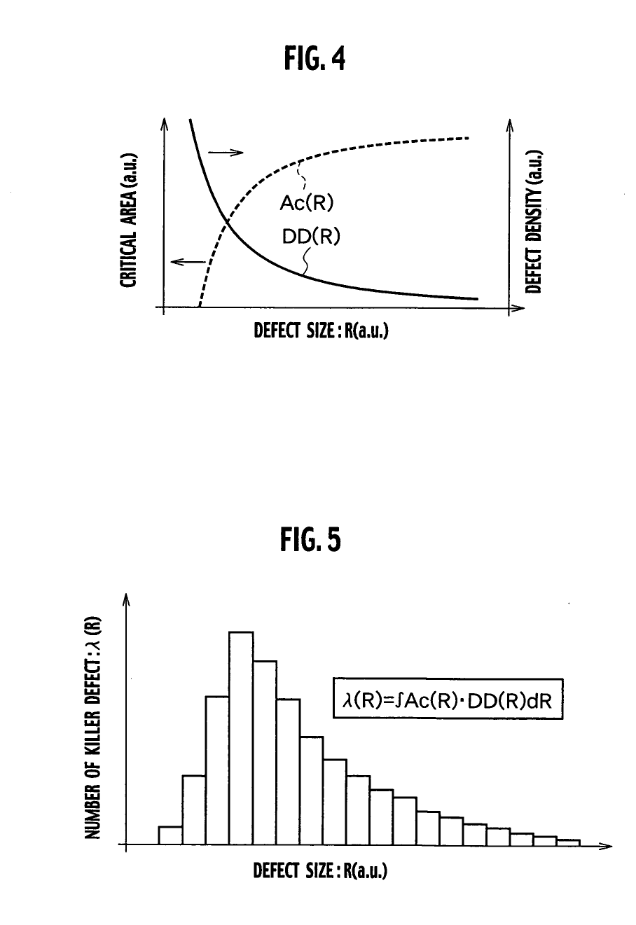

Description will be made for the critical area Ac(R) of each defect size and the predicted defect density distribution DD(R) of each defect size, which are treated by the killer defect calculation module 13 of FIG. 1, and the number of killer defects λ(R) of each defect size, which is calculated based on the critical area Ac(R) and the predicted defect density distribution DD(R), with reference to FIGS. 4 and 5. As shown in FIG. 4, the critical area Ac(R) and the predicted defect density distribution DD(R) vary depending on the defect size R. In general, the smaller the defect size, the higher the predicted defect density distribution DD(R), and the larger the defect size, the lower the predicted defect density distribution DD(R). The smaller the defect size, the narrower the critical area Ac(R), and the larger the defect size, the wider the critical area Ac(R).

As shown in FIG. 5, the number of killer defects λ(R) is changed depending on the defect size R. The number of killer defects λ(R) is obtained by following equation (1).

λ(R)=∫Ac(R)*DD(R)dR (1)

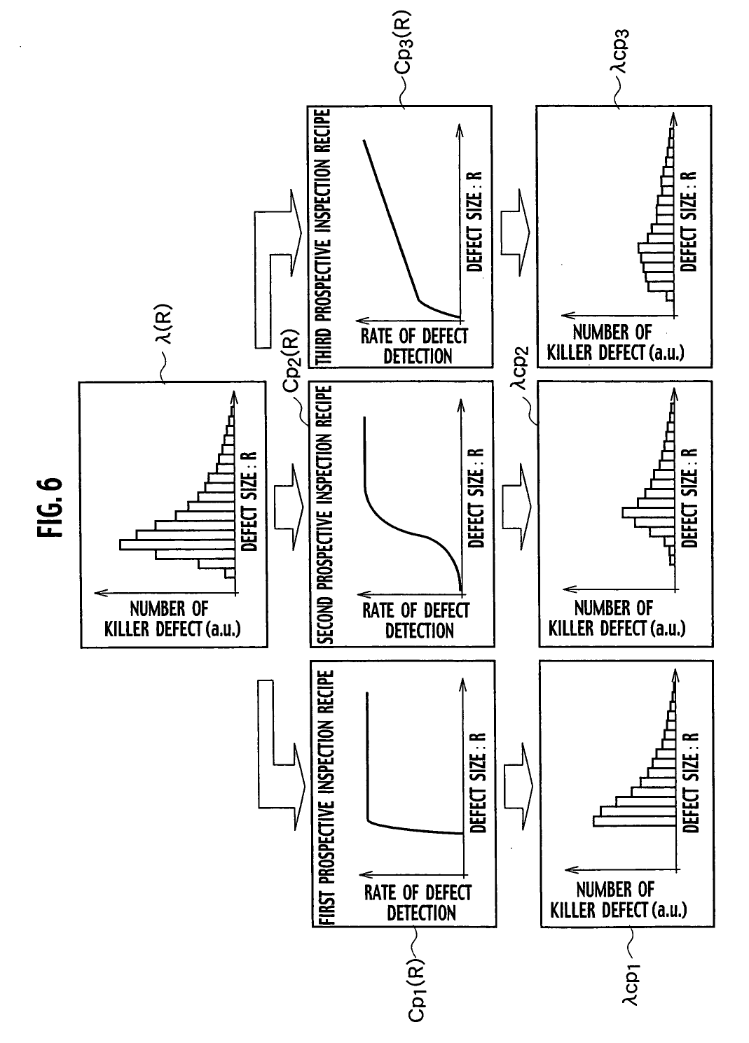

As shown in FIG. 6, the number of killer defects λ(R) is the same as that shown in FIG. 5. First, second and third prospective inspection recipes Cp1 (R), Cp2 (R) and Cp3 (R) are examples of the prospective inspection recipes stored in the prospective inspection recipe storage unit 4 of FIG. 1. The first, second and third prospective inspection recipes Cp1(R), Cp2(R) and Cp3(R) have profiles of rates of defect detection different from one another. A rate of defect detection of the first prospective inspection recipe Cp1(R) is zero until the defect size R reaches a fixed value, and is constant after a sharp increase exceeding the fixed value. A rate of defect detection of the second prospective inspection recipe Cp2(R) gradually increases with an increase of the defect size R, and is constant after the defect size R reaches a fixed value. A rate of defect detection of the third prospective inspection recipe Cp3(R) sharply increases at first, and thereafter, gradually increases at a fixed rate.

The numbers of killer defects λcp1(R), λcp2(R) and λcp3(R) of each defect size, which are expected by the defects detected by the first to third prospective inspection recipes Cp1(R), Cp2(R) and Cp3(R), are respectively provided by following equation (2). In the equation (2), “x” denotes 1, 2 or 3.

λcpx(R)=∫λ(R)*Cpx(R)dR (2)

The optimum inspection recipe determination module 15 shown in FIG. 1, obtains the prospective inspection recipe, in which the number of killer defects expected to be detected is the largest, based on the number of killer defects λcp1 (R), λcp2(R) and λcp3(R) of each defect size. As described above, by use of the equation (1) and the critical area Ac (R) depending on the layout pattern and the defect size, the killer defect calculation module 13 obtains a distribution of the number of killer defects λ(R) in which a failure can occur due to the presence of the defects. Then, the detection expectation calculation module 14 obtains the number of killer defects λcp1 (R), λcp2(R) and λcp3 (R) of each defect size, which are expected to be detected by the plurality of prospective inspection recipes Cp1 (R), Cp2(R) and Cp3 (R), by use of the equation (2). Hence, an inspection recipe, which may efficiently detect a defect that affects a yield rate, can be created easily without depending on the degree of skill of a recipe creator. Moreover, it will become unnecessary for an engineer to repeat inspection and review for a wafer product actually used as an inspection target while adjusting many sensitivity parameters provided in the defect inspection apparatus, and it will not take time to set conditions for the inspection recipe.

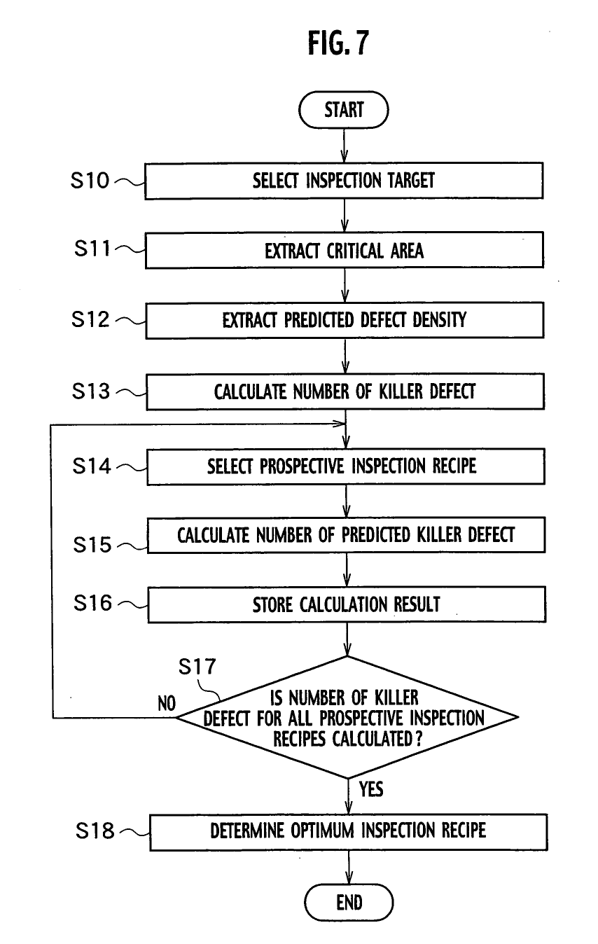

Next, a method for creating an inspection recipe according to the first embodiment of the present invention will be described with reference to FIG. 7. The method for creating an inspection recipe shown in FIG. 7 shows a flow of operations, that is, a procedure of the operation unit 1 in accordance with the program commands stored in the program storage unit 1 shown in FIG. 1.

(a) In Step S10, the inspection target selection module 10 selects the inspection target. Specifically, the inspection target selection module 10 designates the type of the product, the manufacturing process of the product and the region in the product.

(b) In Step S11, the critical area extraction module 11 extracts the critical area Ac(R) of each defect size in the selected inspection target. Specifically, the critical area extraction module 11 reads out the critical area Ac(R) corresponding to the inspection target from the critical area storage unit 2.

(c) In Step S12, the defect density prediction module 12 extracts the predicted defect density distribution DD(R) predicted to be detected in the inspection target for each defect size. Specifically, the defect density prediction module 12 reads out the predicted defect density distribution DD(R) of each defect size in a production line from the predicted defect density storage unit 3.

(d) In Step S13, the killer defect calculation module 13 calculates the number of killer defects λ(R) of each defect size, which is shown in FIG. 5, by use of the equation (1) based on the critical area Ac(R) of each defect size and the predicted defect density distribution DD(R) of each defect size, which are shown in FIG. 4.

(e) In Step S14, the detection expectation calculation module 14 first selects one of the prospective inspection recipes. Specifically, the detection expectation calculation module 14 reads out the information on the rate of defect detection of the prospective inspection recipe from the prospective inspection recipe storage unit 4. Here, description continues regarding the case of selecting the first prospective inspection recipe Cp1(R) of FIG. 6.

(f) In Step S15, the detection expectation calculation module 14 calculates the number of killer defects λcp1(R) of FIG. 6, which is expected to be detected by the selected first prospective inspection recipe Cp1 (R), by use of the equation (2).

(g) In Step S16, the detection expectation calculation module 14 stores the number of killer defects λcp1(R) of FIG. 6 that is a result of the calculation in the detection expectation storage unit 5.

(h) In Step S17, the detection expectation calculation module 14 determines whether or not to calculate the number of killer defects for all of the prospective inspection recipes. If the detection expectation calculation module 14 has not calculated all of the numbers (“NO” in Step S17), the procedure returns to Step S14, where the detection expectation calculation module 14 selects a prospective inspection recipe that has not been selected yet, for example, selects the second or third prospective inspection recipe Cp2(R) or Cp3 (R) of FIG. 6. Then, for the second or third prospective inspection recipe Cp2 (R) or Cp3 (R), the detection expectation calculation module 14 repeatedly implements Steps S15 and S16, and calculates the number of killer defects λcp2(R) and λcp3(R) of FIG. 6. The detection expectation calculation module 14 repeatedly implements Steps S14 to S16 for all of the prospective inspection recipes in such a manner as described above, thus calculating the number of killer defects expected to be detected for each of the plurality of prospective inspection recipes based on the number of killer defects of each defect size and the rate of defect detection prescribed in the prospective inspection recipes. If the detection expectation calculation module 14 has calculated the number of killer defects for all of the prospective inspection recipes (“YES” in Step S17), the procedure proceeds to Step S18.

(i) Finally, in Step S18, the optimum inspection recipe determination module 15 obtains the prospective inspection recipe in which the number of killer defects expected to be detected is the largest. Specifically, the optimum inspection recipe determination module 15 extracts the prospective inspection recipe, in which the number of killer defects is the largest in the number of killer defects λcp1 (R), kcp2 (R) and λcp3 (R), from among the first to third prospective inspection recipes Cp1 (R), Cp2 (R) and Cp3(R). Through the above-described procedure, it is possible to automatically create the inspection recipe which enables the largest number of killer defects to be detected for the selected inspection target.

As described above, in Step S13, by use of the equation (1) and the critical area Ac(R) depending on the layout pattern and the defect size, the distribution of the number of killer defects λ(R) in which a failure can occur due to the presence of the defects of the critical area Ac(R) is obtained. Then, in Step S15, the number of killer defects λcp1(R), λcp2(R) and λcp3(R) of each defect size, which are expected to be detected by the plurality of prospective inspection recipes Cp1(R), Cp2(R) and Cp3 (R), are obtained by use of the equation (2). Hence, the inspection recipe, which may efficiently detect a defect that affects a yield rate, can be easily created without depending on the degree of skill of a recipe creator. Moreover, it will become unnecessary for an engineer to repeat inspection and review for a wafer product that is actually used as an inspection target while adjusting many sensitivity parameters provided in the defect inspection apparatus, and it will not take time to set conditions for the inspection recipe.

As described above, according to the first embodiment of the present invention, it is possible to detect the largest number of killer defects within the performance range of the defect inspection apparatus. Accordingly, it is possible to ascertain the killer defects and to take measures against a process where the defects occur, at an early stage. As a result, it is possible to contribute to an improvement in the yield rate of the product. In addition, it is possible to find the optimum inspection recipe easily, resulting in reduction of time required for creating the inspection recipe.

In addition, when there are a plurality of kinds of defect inspection apparatuses using the inspection recipe created by the system and the method according to the first embodiment, it is necessary to determine which kind of defect inspection apparatus is recommended to be equipped for operating in the manufacturing line. In such case, if information of the prospective inspection recipes corresponding to the plurality of kinds of defect inspection apparatuses is registered in advance in the prospective inspection recipe storage unit 4 of FIG. 1, a condition so as to detect the largest number of killer defects λcp which are found for each of the inspection apparatuses can be obtained. Thus, the optimum defect inspection apparatus equipped for the manufacturing line can be easily determined in accordance with the inspection target such as the kind, manufacturing process and region of the product, and a monitoring environment for the manufacturing line, which makes full use of the performance of each of the variety of defect inspection apparatuses, can be developed.

Moreover, in a manufacturing technology for an electronic device such as a semiconductor device, an inspection process provided in the course of the manufacturing process is required to detect an abnormality and a problematic defect, which occur in the manufacturing process, as quickly as possible. The detection sensitivity of the defect inspection apparatus is varied depending on the structure and material of the inspection target. Accordingly, it is necessary for the engineer to determine in which manufacturing process it is suitable to provide an inspection point. In this case, if information on the rate of the defect detection in the prospective inspection target for each manufacturing process is registered in advance in the prospective inspection recipe storage unit 4 of FIG. 1, a condition so as to detect the largest number of killer defects λcp which are found for each manufacturing process can be obtained. Therefore, it is possible to easily determine the optimum inspection process where the defect inspection apparatus is to be provided.

Furthermore, information of the defect density of a plurality of manufacturing lines may be registered in the predicted defect density storage unit 3 of FIG. 1. Thus, the inspection apparatus and the inspection process, which are suitable to each manufacturing line, can be selected.

Furthermore, information of the rate of the defect detection for each type of defect may be registered in the prospective inspection recipe storage unit 4 of FIG. 1. An inspection recipe focusing on a specific type of defect desired to be detected by the user can be created.

Furthermore, the electronic device provided as the inspection target includes a semiconductor device, a liquid crystal device and the like. In addition, an exposure mask required for manufacturing the electronic device can be subjected to the inspection.

(Second Embodiment)

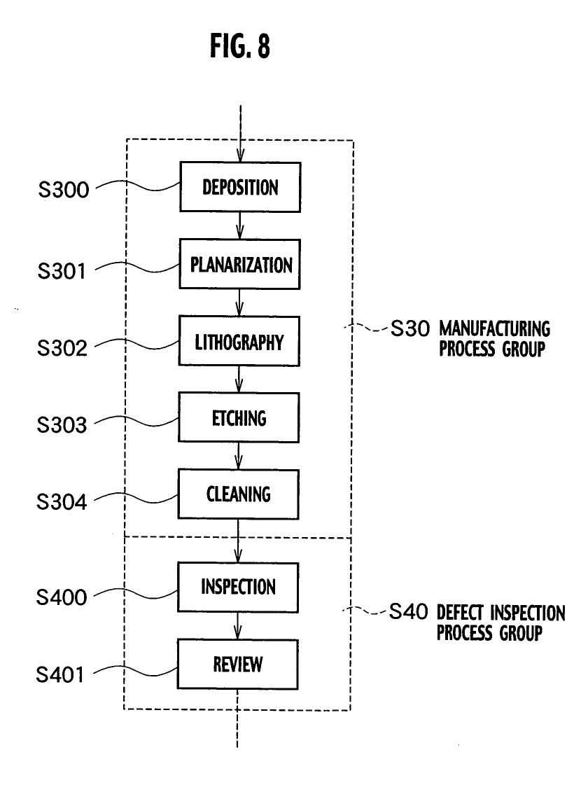

FIG. 8 shows an example of a defect inspection process group S40 provided in a manufacturing line of a semiconductor device. Defect inspection is frequently performed as a checkpoint provided between the respective manufacturing process groups so as to be capable of detecting a defect occurring in each manufacturing process. Hence, the defect inspection process group S40 is implemented after a manufacturing process group S30 for processing a wafer. For example, as the manufacturing process group S30, a thin film of an insulator, a semiconductor or a metal is deposited on the wafer in Step S300, and the deposited thin film is planarized in Step S301. Then, a lithography process for delineating a resist pattern on the thin film is implemented in Step S302, and the thin film is selectively etched by use of the resist pattern as a mask in Step S303. Subsequently, the resist pattern is removed, and the wafer surface is cleaned in Step S304. After implementing the manufacturing process group S30 including Steps S300 to S304, in the defect inspection process group S40, defects on the wafer are inspected in Step S400. Then, the detected defects are reviewed to identify a cause of failure in Step S401. In the second embodiment of the present invention, a system and a method for reviewing the defect, which are used in a review process in Step S401 shown in FIG. 8, will be described.

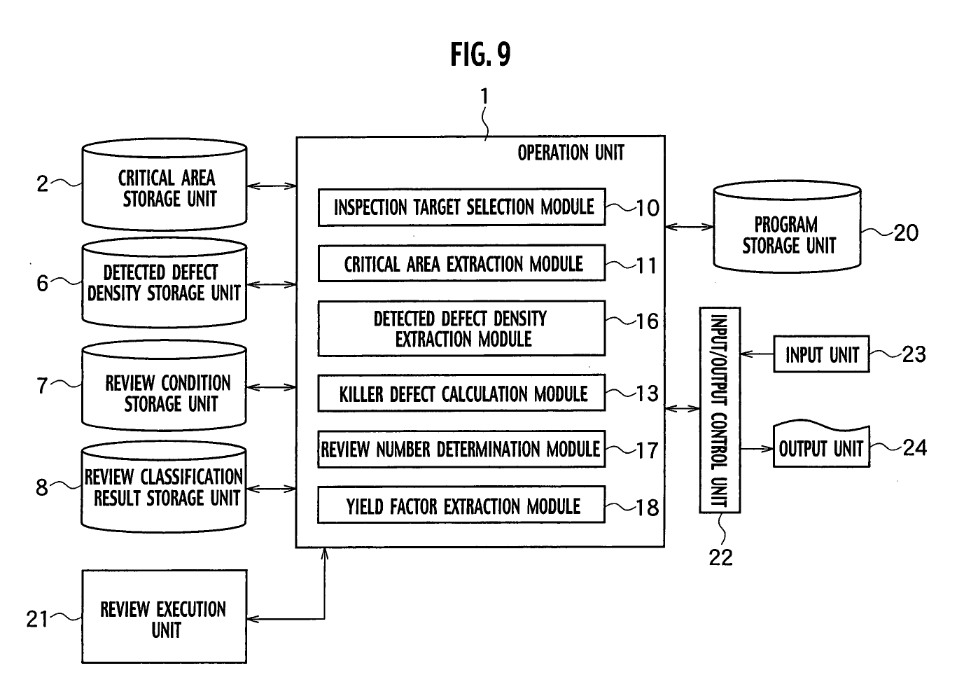

As shown in FIG. 9, the system for reviewing the defect according to the second embodiment of the present invention includes an operation unit 1 having a function to determine the number of defects to be reviewed and to identify a factor which caused the deterioration of a yield rate, and includes a critical area storage unit 2, a detected defect density storage unit 6, a review condition storage unit 7, a review classification result storage unit 8, a program storage unit 20, and a review execution unit 21, which are connected to the operation unit 1.

The operation unit 1 includes an inspection target selection module 10 configured to select an inspection target, a critical area extraction module 11 configured to extract a critical area for each defect size in the inspection target, a detected defect density extraction module 16 configured to extract a defect density for each defect size, which is detected in the inspection target, a killer defect calculation module 13 configured to calculate the number of killer defects for each defect size based on the critical area for each defect size and the defect density for each defect size, a review number determination module 17 configured to obtain a number of defects to be reviewed for each defect size based on the number of killer defects for each defect size, and a yield factor extraction module 18 configured to extract a factor responsible for deteriorating the manufacturing yield based on a result of reviewing the defects detected in the inspection target.

Each of the inspection target selection module 10, the critical area extraction module 11, the detected defect density extraction module 16, the killer defect calculation module 13, the review number determination module 17 and the yield factor extraction module 18 may be provided by dedicated hardware respectively, or by software having a substantially equivalent function using a CPU of a common computer system.

Each of the critical area storage unit 2, the detected defect density storage unit 6, the review condition storage unit 7, the review classification result storage unit 8 and the program storage unit 20 may be provided by an auxiliary storage unit including a semiconductor memory such as a semiconductor ROM, a semiconductor RAM and the like, a magnetic disk unit, a magnetic drum storage unit and a magnetic tape unit, or by a main memory unit in the CPU.

An input unit 23 for receiving an input such as data and a command from an operator, and an output unit 24 for providing data of the number of defects to be reviewed and the factor responsible for deteriorating the yield rate are connected to the operation unit 1 through the input/output control unit 22.

For example, the inspection target selection module 10 designates a type of a product, a manufacturing process of the product and a region in the product as the inspection target. The critical area extraction module 11 extracts the critical area for each defect size in the inspection target selected by the inspection target selection module 10 from the critical area storage unit 2. The detected defect density extraction module 16 extracts the defect density for each defect size, which is detected in the inspection target, from the detected defect density storage unit 6. The killer defect calculation module 13 calculates the number of killer defects for each defect size based on information of the critical area extracted by the critical area extraction unit 11 and the detected defect density extracted by the detected defect density extraction module 16. The review number determination module 17 calculates the number of defects to be reviewed for each defect size based on the number of killer defects for each defect size, which is calculated by the killer defect calculation module 13, and the review condition registered in the review condition storage unit 7. The yield factor extraction module 18 extracts a problematic defect and a problematic process, which affect the manufacturing yield, based on information of a review classification result stored in the review classification result storage unit 8.

The critical area storage unit 2 stores information of the critical areas corresponding to each inspection target of the type of the product, the manufacturing process of the product and the region in the product. The detected defect density storage unit 6 stores information of the defect density actually detected by the defect inspection apparatus in the inspection target product. The information of the defect density includes an identification number, the number of defects, the size, coordinate information and the like of the defects detected by the defect inspection apparatus. Moreover, the detected defect density storage unit 6 may store the result of compiling the detected defects for each defect size.

Specifically, the information stored by the detected defect density storage unit 6 may be first information provided by summarizing the numbers of defects and the defect sizes for each wafer or second information provided by converting the first information into the defect density for each defect size. Hence, when the information of the defect density is the second information, the detected defect density extraction module 16 directly extracts the defect density for each defect size from the detected defect density storage unit 6. When the information of the defect density is the first information, the detected defect density extraction module 16 reads out the first information from the detected defect density storage unit 6, and converts the first information into the second information to extract the defect density for each defect size.

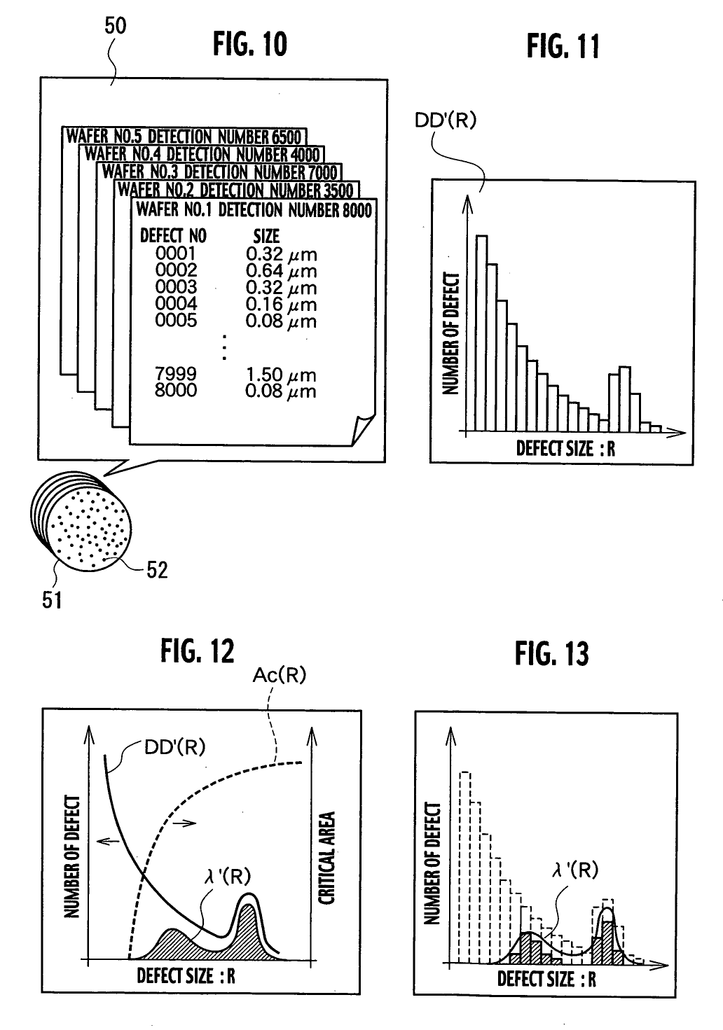

For example, as shown in FIG. 10, an example of a detected defect information 50 concerning respective defects 52 on a wafer 51, which are detected by the defect inspection apparatus, is stored in the detected defect density storage unit 6 of FIG. 9. In the detected defect information 50, the identification numbers and the defect sizes are summarized for each wafer. The example shown in FIG. 10 shows a case where a total of 20,000 defects have been detected from the wafers No. 1 to No. 5. As shown in FIG. 11, the detected defect density distribution DD′(R) for each defect size, which is summarized based on the detected defect information 50 of FIG. 10, may be stored in the detected defect density storage unit 6 of FIG. 9. In the example shown in FIG. 11, a peak of the detected defect density distribution DD′(R) emerges in a certain defect size. As shown in FIG. 12, the killer defect calculation module 13 of FIG. 9 provides a number of killer defects λ′(R) for each defect size by use of the equation (1) based on the information of the detected defect density distribution DD′(R) for each defect size and the critical area Ac(R) for each defect size. In the example shown in FIG. 12, the peak of the detected defect density distribution DD′(R) is reflected on a profile of the number of killer defects λ′(R). As shown in FIG. 13, the review number determination module 17 of FIG. 9 calculates the number of defects to be reviewed for each defect size based on the number of killer defects λ′(R) for each defect size and a review condition. In the example shown in FIG. 13, the peak of the detected defect density distribution DD′(R) is also reflected on the number of defects to be reviewed.

The review condition storage unit 7 stores a condition for reviewing the defect detected in the inspection target. The review condition includes a condition that designates the number of defects to be reviewed or a review sampling rate. The review sampling rate indicates a rate of the number of defects to be reviewed to the number of defects detected by the defect inspection apparatus. In the review classification result storage unit 8, results of reviewing the defects provided by the review execution unit 21 are stored while being categorized so as to distinguish characteristics of an occurrence source of the defects and the like.

The review execution unit 21 is a review apparatus for observing and classifying the defects in accordance with the number of defects to be reviewed, which has been calculated by the review number determination module 17. A review result of the review number determination module 17 is stored in the review classification result storage unit 8.

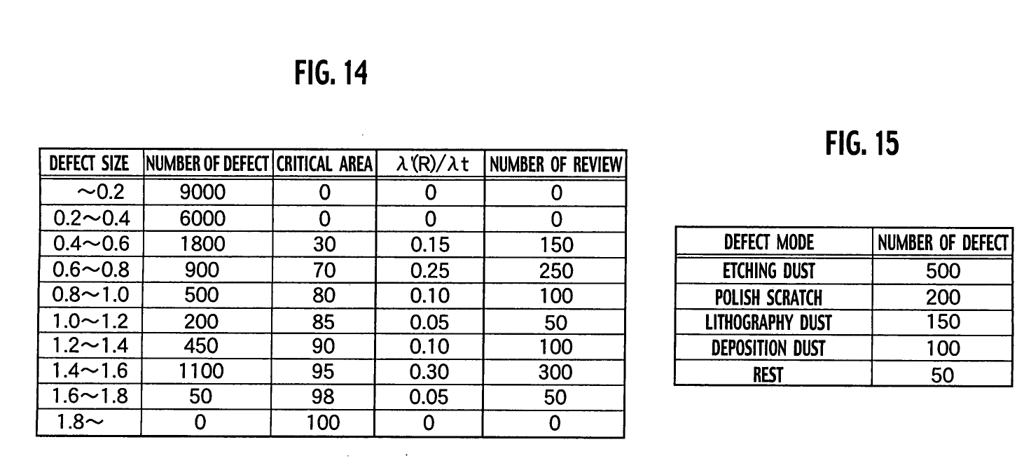

As shown in FIG. 14, for each defect size, the detected defect density distribution DD′(R) is summarized, and the critical area Ac(R) is defined. Here, the total of the detected defects is 20,000. Then, the number of killer defects λ′(R) is calculated by use of the equation (1). In FIG. 14, a rate of the number of killer defects λ′(R) for each defect size to the total number λt of the killer defects λ′(R) of FIG. 12 is shown. The rate (λ′(R)λt) shown in FIG. 14 corresponds to a “yield impact rate” indicating a degree of influence given to the manufacturing yield by the defects. The number of defects Rc(R) to be reviewed is identified in accordance with the yield impact rate and the following equation (3). Here, a total review count “Trc” denotes the total number of defects to be reviewed.

Rc(R)=Trc*{λ′(R)/λt} (3)

The example shown in FIG. 14 corresponds to a case where the total review count Trc is 1,000, that is, where the sampling rate is 5%. FIG. 15 shows the number of defects for each defect mode, which have been observed and classified by the review execution unit 21. An “etching dust” is a dust generated in the etching process S303 of FIG. 8. A “polish scratch” is a scratch generated in the planarization process S301. A “lithography dust” is a dust generated in the lithography process S302. A “deposition dust” is a dust generated in the deposition process S300. The yield factor extraction module 18 sorts the defect modes shown in FIG. 15 in a descending order of the number of defects. Consequently, a problematic defect and a problematic process, which largely affect the yield rate, are extracted. In the example shown in FIG. 15, the yield factor extraction module 18 estimates that the etching dust is the factor responsible for deteriorating the yield rate.

As described above, by use of the equation (1) and the critical area Ac(R) depending on the layout pattern and the defect size, the killer defect calculation module 13 obtains the distribution of the number of killer defects λ′(R) in which a failure can occur due to the presence of the defects of the critical area Ac(R). Then, the review number determination module 17 obtains the number of defects to be reviewed by use of the number of killer defects λ′(R) for each defect size and the number of defects Trc and the like to be reviewed as a review condition. Hence, by the system for reviewing the defects according to the second embodiment, the defects that largely affect the yield rate can be efficiently reviewed. Consequently, the problematic defect and the problematic process can be predicted in real time. Accordingly, since it is possible to ascertain the killer defects and take measures at an early stage against a process where the defects occur, it is highly effective in achieving a steep increase of the yield rate of the product.

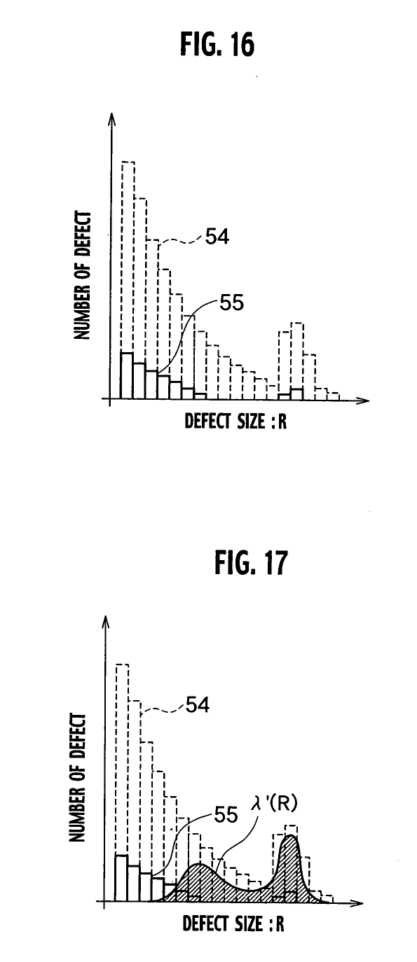

As shown in FIG. 16, in a current defect review system, review classifying is implemented for all of detected defects 54 detected by the defect inspection apparatus. Alternatively, in a state where the detected defects 54 frequently occur, review defects 55 to be reviewed are determined by a random sampling for the defects without considering the degree of influence on the yield rate. Hence, as shown in FIG. 17, the current defect review system has been extremely inefficient for the number of killer defects λ′(R) shown in FIG. 13. By use of the system for reviewing the defect according to the second embodiment of the present invention, it is possible to efficiently review the defects that have a large affect on the yield rate.

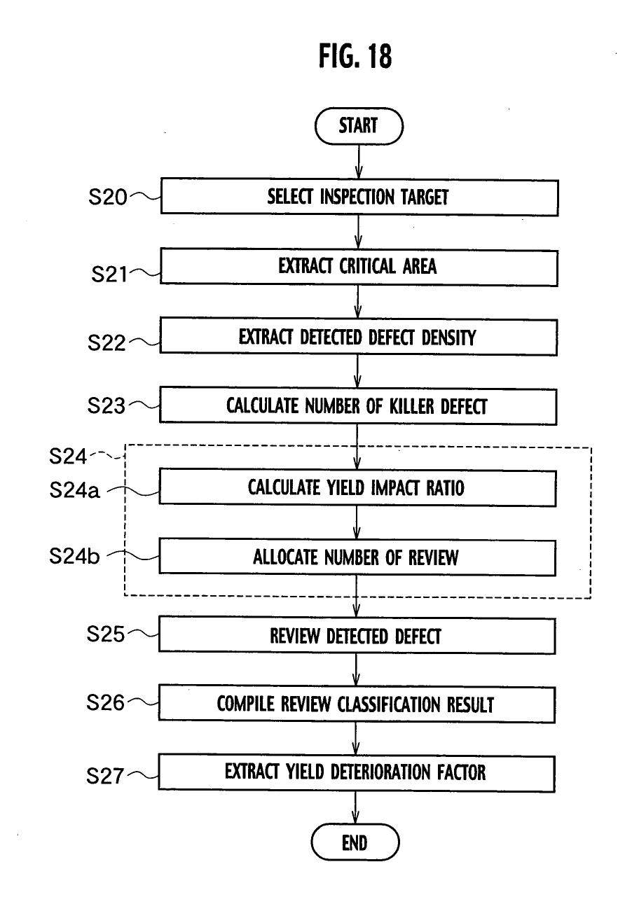

Next, a method for reviewing the defect according to the second embodiment of the present invention will be described with reference to FIG. 18. The defect review method shown in FIG. 18 shows a flow of operations, that is, a procedure of the operation unit 1 in accordance with the program commands stored in the program storage unit 1 shown in FIG. 9.

(a) In Step S20, the inspection target selection module 10 of FIG. 9 selects the inspection target. Specifically, the inspection target selection module 10 designates the type of the product, the manufacturing process of the product and the region in the product.

(b) In Step S21, the critical area extraction module 11 of FIG. 9 extracts the critical area Ac(R) for each defect size from the selected inspection target. Specifically, the critical area extraction module 11 reads out the critical area Ac(R) corresponding to the inspection target from the critical area storage unit 2 of FIG. 9.

(c) In Step S22, the detected defect density extraction module 16 extracts the defect density distribution DD′(R) for each defect size, which has been detected in the inspection target. Specifically, the detected defect density extraction module 16 reads out the defect density DD′(R) for each defect size from the detected defect density storage unit 6, which has been detected by the defect inspection apparatus.

(d) In Step S23, the killer defect calculation module 13 of FIG. 9 calculates the number of killer defects λ′(R) for each defect size by use of the equation (1) based on the critical area Ac(R) for each defect size and the defect density distribution DD′(R) for each defect size, which are shown in FIG. 12.

(e) In Step S24a, the review number determination module 17 of FIG. 9 first calculates the yield impact rate for each defect size. For example, as shown in FIG. 14, the yield impact rate for each defect size is the rate of the number of killer defects λ′(R) for each defect size to the total number of the killer defects λt.

(f) In Step S24b, the review number determination module 17 obtains the number of reviews for each defect size from the yield impact rate for each defect size in accordance with the review condition, such as the total review count, stored in the review condition storage unit 7 of FIG. 9. For example, when the sampling rate is 5%, the number of reviews for each defect size is obtained for the number of defects shown in FIG. 14. Thus, through Steps S24a and S24b, the review number determination module 17 can calculate the number of defects to be reviewed for each defect size based on the number of killer defects λ′(R) for each defect size and the review condition (Step S24). The defects to be reviewed are determined by randomization and the like under the designated review condition and sent to the review execution unit 21.

(g) In Step S25, the review execution unit 21 of FIG. 9 reviews the defects detected in the inspection target in accordance with the number of defects to be reviewed. Note that the defect review may be executed by an apparatus having an automatic defect classification (ADC) function or by defect classification by a human.

(h) In Step S26, the review execution unit 21 summarizes a result of the review classification performed thereby, for example, as shown in FIG. 15. A result of the summarization is stored in the review classification result storage unit 8.

(i) Finally, in Step S27, the yield factor extraction module 18 of FIG. 9 extracts the factor for deteriorating the manufacturing yield based on the result of reviewing the defects detected in the inspection target. Specifically, the yield factor extraction module 18 sorts the defect modes shown in FIG. 15 in the descending order of the number of defects. As a result, the problematic defect and the problematic process, which highly affect the yield rate, are extracted. In the example shown in FIG. 15, the yield factor extraction module 18 predicts that the etching dust is the factor responsible for deteriorating the yield rate. Through the above procedure, it is made possible to obtain the number of defects to be reviewed for each defect size for the selected inspection target and to review the killer defects.

As described above, in Step S23, by use of the equation (1) and the critical area Ac(R) depending on the layout pattern and the defect size, the distribution of the number of killer defects λ′(R) in which a failure can occur due to the presence of the defects of the critical area Ac(R) is obtained. Then, in Step S24, the number of defects to be reviewed is obtained for each defect size by use of the number of killer defects λ′(R) for each defect size. Hence, according to the method for reviewing the defect according to the second embodiment, the defects that have a large affect on the yield rate can be efficiently reviewed. Consequently, the problematic defect and the problematic process can be estimated in real time. Therefore, since it is possible to ascertain the killer defects and take measures at an early stage against a process where the defects occur, the process is greatly effective in achieving a steep increase of the yield rate of the product.

Note that the electronic device which may serve as the inspection target includes a semiconductor device, a liquid crystal device and the like. In addition, an exposure mask and the like, which are required for manufacturing the electronic device, can also be subjected to the inspection.

Additionally, the yield factor extraction module 18 shown in FIG. 9 is included in the operation unit 1 in the second embodiment. However, the yield factor extraction module 18 of the present invention is not limited to being included in the operation unit 1. The yield factor extraction module 18 may be provided by use of an apparatus different from the operation unit 1.

Each of the method for creating the inspection recipe and the method for reviewing the defect, which has been described above, can be expressed by a “procedure”, in which a series of processes or operations are conducted in a time series. Hence, each of the methods can be configured as a program for identifying a plurality of functions achieved by a processor and the like in a computer system in order to execute each of the methods by use of the computer system. Moreover, the program can be stored in a computer-readable recording medium. The recording medium is read into the computer system, and the program stored in a main memory of the computer is executed. Thus, it is possible to achieve each of the methods by computer control. The recording medium may be used as the program storage unit 20 shown in FIGS. 1 and 9, or is read thereinto. Thus, the program enables a variety of operations in the operation unit 1 to be executed in accordance with a predetermined procedure. Here, the recording medium that stores the program includes a memory unit, a magnetic disk unit, an optical disk unit, and any other unit capable of recording the program.

(Other Embodiments)

The inspection process in Step S400 shown in FIG. 8 can be implemented for the wafer by use of the system for creating the inspection recipe and the method for creating the inspection recipe, which are shown in FIGS. 1 and 7, respectively. Then, the review process in Step S401 can be implemented for the wafer by use of the system for reviewing the defect and the method for reviewing the defect, which are shown in FIGS. 9 and 18. In other words, the defect inspection process group S40 shown in FIG. 8 can be implemented by combining the first and second embodiments.

Various modifications will become possible for those skilled in the art after receiving the teachings of the present disclosure without departing from the scope thereof.

What is claimed is:

1. A system for creating an inspection recipe, comprising:
an inspection target selection module configured to select an inspection target;
a critical area extraction module configured to extract corresponding critical areas for a plurality of defect sizes in the inspection target, respectively;
a defect density prediction module configured to extract corresponding defect densities for the defect sizes, the defect densities being predicted by defects to be detected in the inspection target, respectively;
a killer defect calculation module configured to calculate corresponding numbers of killer defects in the defect sizes, based on the critical areas and the defect densities; and
a detection expectation calculation module configured to calculate respectively another numbers of the killer defects expected to be detected for a plurality of prospective inspection recipes which determine rates of defect detection for the defect sizes, based on the numbers of the killer defects and the rates of defect detection prescribed in the prospective inspection recipes.

2. The system of claim 1, further comprising an optimum inspection recipe determination module configured to obtain a prospective inspection recipe in which the another number of the killer defects is the largest.

3. The system of claim 1, further comprising:
a critical area storage unit configured to store the critical areas;
a predicted defect density storage unit configured to store the defect densities; and
an prospective inspection recipe storage unit configured to store the prospective inspection recipes.

4. The system of claim 1, wherein the inspection target selection module designates a type of product, a manufacturing process of the product and a region in the product.

5. The system of claim 1, wherein the calculation of the numbers of the killer defects is an integral of products of the critical areas and the defect densities with the defect sizes, respectively.

6. A system for reviewing a defect, comprising:
an inspection target selection module configured to select an inspection target;
a critical area extraction module configured to extract corresponding critical areas for a plurality of defect sizes in the inspection target, respectively;
a detected defect density extraction module configured to extract corresponding defect densities for the defect sizes, respectively, the defect densities being detected in the inspection target;
a killer defect calculation module configured to calculate corresponding numbers of killer defects in the defect sizes, respectively, based on the critical areas and the defect densities; and
a review number determination module configured to obtain corresponding numbers of defects to be reviewed for the defect sizes based on the numbers of the killer defects, respectively.

7. The system of claim 6, further comprising:
a review execution unit configured to review the defects detected in the inspection target in accordance with the numbers of the defects to be reviewed, respectively; and
a yield factor extraction module configured to extract a factor responsible for deterioration of a manufacturing yield based on a result of reviewing the defects detected in the inspection target.

8. The system of claim 6, further comprising:
a critical area storage unit configured to store the critical areas;
a detected defect density storage unit configured to store the defect densities; and
a review condition storage unit configured to store a condition for reviewing the defects detected in the inspection target.

9. The system of claim 6, wherein the inspection target selection module designates a type of product, a manufacturing process of the product and a region in the product.

10. The system of claim 6, wherein the calculation of the numbers of the killer defects is an integral of products of the critical areas and the defect densities with the defect sizes, respectively.

11. The system of claim 6, wherein the numbers of the defects to be reviewed are products of values obtained by dividing the numbers of the killer defects for the defect sizes by a total number of the killer defects and a total number of the defects to be reviewed.

12. A computer implemented method for creating an inspection recipe, comprising:
selecting an inspection target;
obtaining corresponding critical areas for a plurality of defect sizes in the inspection target, respectively;
obtaining corresponding defect densities for the defect sizes, the defect densities being predicted by defects to be detected in the inspection target, respectively;
calculating corresponding numbers of killer defects in the defect sizes, respectively, based on the critical areas and the defect densities; and
calculating respectively another numbers of the killer defects expected to be detected for a plurality of prospective inspection recipes which determine rates of defect detection for the defect sizes, based on the numbers of killer defects and the rates of defect detection prescribed in the prospective inspection recipes.

13. The method of claim 12, further comprising obtaining a prospective inspection recipe in which the another number of the killer defects expected to be detected is the largest.

14. The method of claim 12, wherein the inspection target includes a type of product, a manufacturing process of the product and a region in the product.

15. The system of claim 12, wherein the numbers of the killer defects are calculated by integrals of products of the critical areas and the defect densities with the defect sizes, respectively.

16. A computer implemented method for reviewing a defect, comprising:
selecting an inspection target;
obtaining corresponding critical areas for a plurality of defect sizes in the inspection target, respectively;
obtaining corresponding defect densities for the defect sizes, respectively, the defect densities being detected in the inspection target;
calculating corresponding numbers of killer defects in the defect sizes, respectively, based on the critical areas and the defect densities; and
obtaining corresponding numbers of the defects to be reviewed for the defect sizes based on the numbers of the killer defects, respectively.

17. The method of claim 16, further comprising:
reviewing the defects detected in the inspection target in accordance with the numbers of the defects to be reviewed; and
extracting a factor responsible for deterioration of a manufacturing yield based on a result of reviewing the defects detected in the inspection target.

18. The method of claim 16, wherein the inspection target includes a type of product, a manufacturing process of the product and a region in the product.

19. The system of claim 16, wherein the numbers of killer defects are calculated by integrals of products of the critical areas and the defect densities with the defect sizes, respectively.

20. The system of claim 16, wherein the numbers of the defects to be reviewed for the defect sizes are provided as products of values obtained by dividing the numbers of the killer defects in the defect sizes by a total number of the killer defects and a total number of the defects to be reviewed.
